(19) United States
(12) Patent Application Publication
(10) Pub. No.: US 2014/0379272 A1
(43) Pub. Date: Dec. 25, 2014

(54) LIFE ANALYSIS SYSTEM AND PROCESS FOR PREDICTING AND FORECASTING LIFE EVENTS

(71) Applicant: ARUNA SATHE, Sierra Madre, CA (US)

(72) Inventor: ARUNA SATHE, Sierra Madre, CA (US)

(21) Appl. No.: 14/315,185

(22) Filed: Jun. 25, 2014

Related U.S. Application Data
(60) Provisional application No. 61/839,008, filed on Jun. 25, 2013.

(51) Int. Cl. G06N 5/04

(52) U.S. Cl. CPC G06N 5/04
USPC 702/19

(57) ABSTRACT

A process for predicting and forecasting life events and a system that performs a life analysis of a person and predicts life events, milestones, and other life paths are disclosed. Predictability and intelligent forecasting of life statuses, milestones, and achievements are provided through a unique combination of algorithms, heuristic rules, data analytics and digitization.

### CLAIM OF BENEFIT TO PRIOR APPLICATION

This application claims benefit to U.S. Provisional Patent Application 61/839,008, entitled “LIFE ANALYSIS SYSTEM FOR PREDICTING AND FORECASTING LIFE EVENTS,” filed Jun. 25, 2013. The U.S. Provisional Patent Application 61/839,008 is incorporated herein by reference.

### BACKGROUND

Embodiments herein relate generally to a predicting and forecasting life events, and more particularly to a system and process for forecasting life events, milestones, and other status indicators based on a personalized set of criteria.

People with similar geographic, academic, professional, financial and other such characteristics follow similar life paths in terms of achievements and milestones. Many such persons would like a way to forecast their own life path, but typically fail to consider or minimize the impact of many of the events, challenges, and pathways that are likely to be present over a number of years in the person's life. Thus, personal forecasting is typically error prone and inaccurate. This is problematic for those who would like to have accurate predictions in order to make decisions that better serve the person's goals and ambitions, and thereby further enrich the person's life.

Also, most of the existing systems for predicting and forecasting life events are based on a narrow set of criteria limited to the person's past. In most cases, they attempt to tackle present problems or forward-thinking questions using antiquated information from the past under the belief that the person will simply act is a similar way and with a similar mindset for any issue that crops up in a person's life. As such, the existing systems fail to include outside characteristics, such as the geographic, academic, professional, financial characteristics of similarly situated people. Typically this means that there is no way for a person to determine his or her likely future based on intelligent assimilation, comparison and analysis of data based on others' achievements and similarity of characteristics. This is problematic because many people tread similar paths depending upon cultural, academic, financial, professional, and other characteristics. Learning from each other and real people provides limitless possibilities for enriching one's life.

Thus, what is needed is a system to proactively inform and determine what might be around the proverbial corner or what people might need even before they realize it. The system should include a high level of predictability using intelligent algorithms, rules, and data analytics, and should securely perform data aggregation and dissection to predict potential life events, milestones, and statuses with a high degree of accuracy.

### BRIEF DESCRIPTION

Some embodiments of the invention include a novel system that performs a life analysis of a person and predicts life events, milestones, and other life paths based on the analysis. In some embodiments, the life analysis system provides an interactive service for users to access the system by user computing devices over a network. In some embodiments, the system provides the interactive service by performing a process in which predictability and intelligent forecasting of life statuses, milestones, and achievements are provided through a unique combination of algorithms, heuristic rules, data analytics and digitization.

Some embodiments of the invention include a novel process for predicting and forecasting life events. In some embodiments, the process receives user profile information of a user, receives a set of search criteria, performs a search based on the profile and search criteria, and provides custom search results to the user.

In some embodiments, an interactive process is performed by a user to interact with the life analysis system and define custom search criteria that the system uses to identify similarly situated users and provide search results including a set of life events, advice, milestones, or other life paths to the user. After interacting with the life analysis system and receiving the search results, the user may then make one or more life decisions.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a block diagram of a network architecture for a life analysis system in some embodiments that predicts and forecasts life events of a person.

FIG. 2 conceptually illustrates a process for a person to make life decisions based on life events predicted and forecast by the life analysis system in some embodiments.

FIG. 3 conceptually illustrates a process for predicting and forecasting life events in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

### I. Life Analysis System to Predict and Forecast Life Events

As stated above, people with similar geographic, academic, professional, financial and other such characteristics tend to follow similar life paths in terms of achievements and milestones. People can therefore benefit, avoid mistakes, and/or otherwise improve themselves by tapping into the detailed actions of similarly situated people.

Some embodiments of the invention include a novel system that performs a life analysis of a person and predicts life events, milestones, and other life paths based on the analysis. In some embodiments, the life analysis system provides an interactive service for users to access the system by user computing devices over a network. In some embodiments, the system provides the interactive service by performing a process in which predictability and intelligent forecasting of life statuses, milestones, and achievements are provided through a unique combination of algorithms, heuristic rules, data analytics and digitization.

The life analysis system in some embodiments comprises a single, consolidated, secure and risk-free platform that allows people to benefit by understanding what others in similar situations are currently doing, buying, planning, and making and what those others have previously done, bought, planned, and made.

The system offers people greater benefits over existing systems. Almost all of the existing systems are question and answer types of systems. In these systems, people can ask free-form questions that seem arbitrary and untethered from any particular theme or structure. Moreover, others can respond to free-form questions in these systems in similarly arbitrary manner, sometimes appearing as cryptically worded responses that are open to wide interpretation and sometimes verbosely, without any formal structure or organization. Thus, the existing systems to date offer no ability to reasonably predict what a person might need in the future.

In contrast, the life analysis system of some embodiments performs a life analysis of a person and predicts life events, milestones, and other life paths based on the analysis. In some embodiments, the system comprises a web server that publishes an interactive web site on the Internet, an application server that performs user and data validation, a database that includes a set of life parameters of a set of people, and a set of applications that perform a set of life analysis operations based on the set of life parameters. Users interact with the system over the Internet with a user computer.

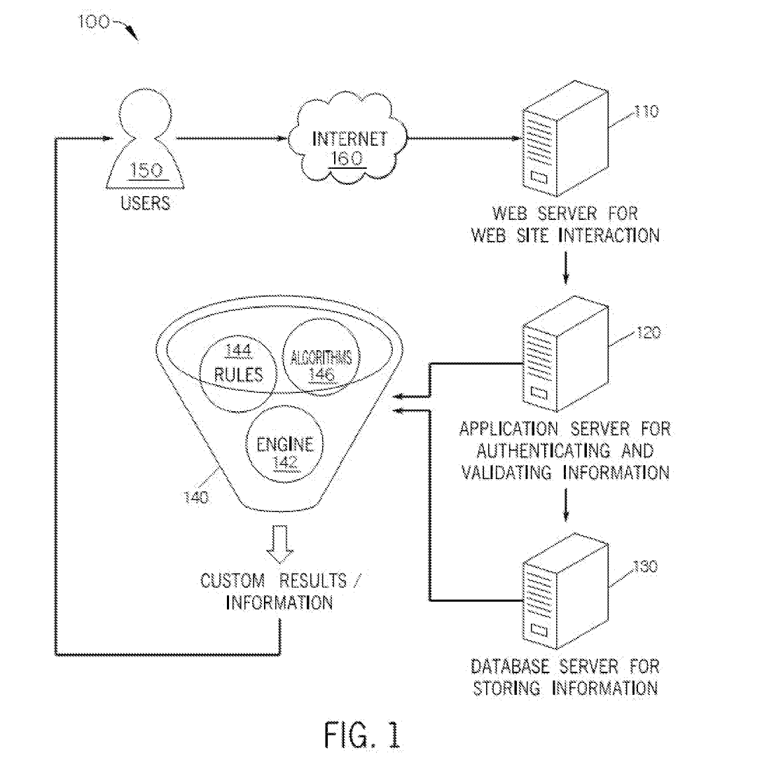

By way of example, FIG. 1 conceptually illustrates a block diagram of a life analysis system 100 that predicts and forecasts life events of a person. As shown in this figure, the system includes a web server 110 for web site interaction, an application server 120 for authenticating and validating information, a database server 130 for storing information, and a set of applications that perform a set of life analysis operations 140 based on a set of life parameters provided by each user 150 who uses a computing device to connect to and interact with the system 100 over the Internet 160.

In some embodiments of the life analysis system 100, the set of life analysis operations 140 are performed and/or constrained by a processing engine 142, a set of rules 144, and a set of algorithms 146. In some embodiments, the set of life analysis operations 140 comprises intelligent assimilation, comparison, and analysis of data based on the achievements of other persons and the similarity of characteristics to the other persons. In some embodiments, the set of life parameters includes one or more of a set of life events, a set of milestones, and a set of life statuses. In some embodiments, the set of people includes the user. In some embodiments, the set of people further includes a set of persons that are similarly situated to the user.

As such, the life analysis system 100 in these embodiments allows people to learn from real people and real-life examples rather than only from so-called “experts” who typically are unlikely to have had as many or as qualitatively rich experiences as their clients. As a result, so-called “experts” have limited knowledge and limited experiences to draw from when predicting and forecasting a person's future life events. Because people learn best by real-world examples, the system of some embodiments of the invention allows people all over the world to maximize the learning experience with as many qualitatively rich examples as needed for self improvement.

While the examples described in Section I pertain to the overall life analysis system, in some embodiments, processes are performed to drive the analysis of a specific person's life and to perform all the operations needed to forecast and/or predict life events in the specific person's life. Thus, in Section II, a user-driven process for interacting with a life analysis system is described in sub-Section A, followed by a process for making life decisions, in sub-Section B.

### II. Processes for Making Life Decisions

A. User Driven Process for Interacting with the Life Analysis System

In some embodiments, an interactive process is performed by a user to interact with the life analysis system and define custom search criteria that the system uses to identify similarly situated users and provide search results including a set of life events, advice, milestones, or other life paths to the user. After interacting with the life analysis system and receiving the search results, the user may then make one or more life decisions.

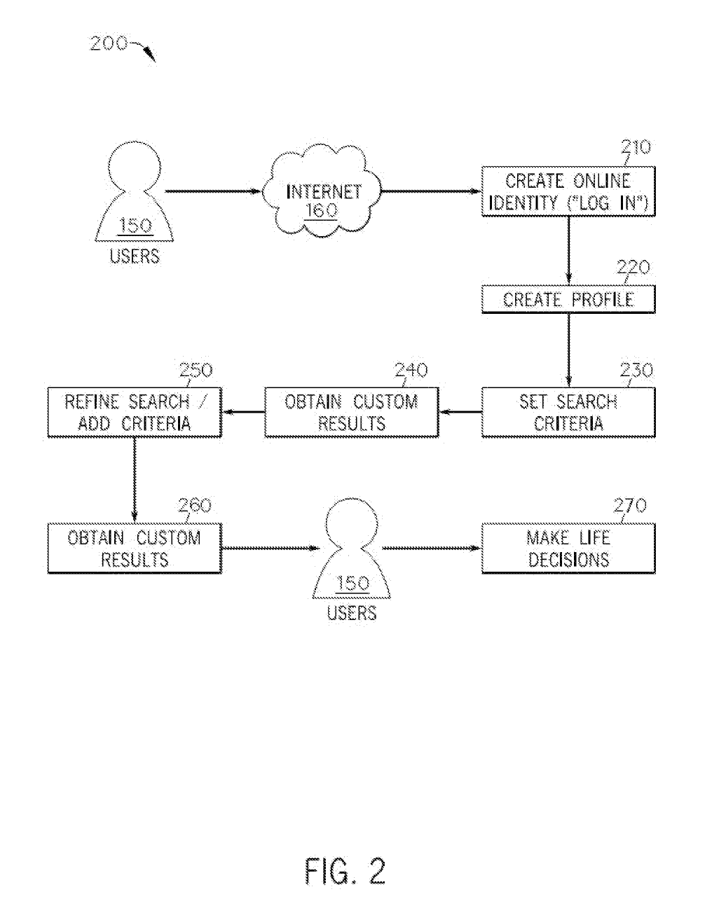

By way of example, FIG. 2 conceptually illustrates a process 200 for a person to make life decisions based on life events predicted and forecast by the life analysis system 100. As shown in this figure, multiple users 150 may interact with the life analysis system 100 via computing device peripherals and input devices, such as a keyboard, a mouse, a monitor, etc. In this example, a specific user, among the several users 150 who may contemporaneously connect and interact with the system 100, connects to the system 100 via computing device that is connected to a computer and data network (e.g., an Internet connection). The user 150 communicates with a centralized expert system and rules engine that stores user input, determines results of searches as they relate to life situations and users' criteria. However, the user may need to perform preliminary interactive operations, such as logging into the system 100 and/or creating a user ID/profile.

As shown in FIG. 2, the user 150 first creates an online/system log in ID (at 210). In some embodiments of the life analysis system 100, users have to create an online identity that creates a secure profile. Creation of an online identity (“log in”) involves using identifying contact methods, for instance, a real email address, a user ID or username, and a password. In some embodiments, the system checks for duplicate user identities so that each user is ensured of having a unique ID to access the system 100. To do so, the system may use one or more algorithms to check for duplicates, which are described further below.

Upon successful creation of a log in users can proceed to answer profile questions that describe their characteristics such as age, geographic location, academic status, financial status, health status, etc. Thus, the user will specify one or more options to create a user profile (at 220) in the system 100. Once a profile is created users can proceed to search for others' statuses and milestones based on characteristics in their profile or alternate characteristics. While the user may be new to the system 100, in some cases, a user of the system 100 is a return user who already has a login ID and/or user profile. In this case, the user would simply move forward past the login ID and profile creation steps and proceed to the next step of setting search criteria (at 230).

The search criteria, along with the user profile data, are then processed by the expert system and rules engine to identify possible life events and generate a set of results for the user. Thus, the user would next obtain the custom results (at 240) from the expert system after processing. The system may process the search criteria and identify a set of relevant results using one or more algorithms, which are described further below.

Results from the expert system and rules engine are provided in a text and graphical format to help users better understand their life situations and make intelligent decisions about their life, avoid mistakes, and, overall, improve current and future life situations. Without such a data-driven, rules-based, analytical, expert system people would continue to make mistakes that others have made and not benefits from others' knowledge and experiences.

Referring back to FIG. 2, if the results are satisfactory, the user may proceed to the last stage of making one or more life decisions (at 270). On the other hand, if the user would like to refine the results, the user would begin by refining the search criteria, either editing the existing criteria, adding new criteria, or removing existing criteria (at 250). Then the expert system would process the refined search criteria and provide an updated result set to the user. When the user obtains the updated result set (at 260), the user may then choose to accept the results. Then the user is in position to make one or more life results (at 270). As above, however, if the user is not satisfied with the results, it is possible to further refine the search criteria and have new results generated by the system 100. Thus, users 150 are able to interact with the life analysis system 100 by way of this process 200. As a person skilled in the art would appreciate, different operations and different ordering of operations would be possible without changing the outcome of the process 200.

The following rules and algorithms are examples of the types of algorithms and rules that would be utilized in the functioning of the life analysis system.

Algorithm for Determining Duplicate Log In Names

Step 1: Obtain Log In name provided by prospective/new user.

Step 2: Store Log In name in computer server memory or in a temporary database.

Step 3: Compare Log In names stored in server memory or temporary database with all previously approved Log In names stored in the permanent database.

Step 4: If a match is found inform prospective/new user to select a different user name. If a match is not found accept the Log In name and store it in the permanent database.

Algorithm for Searching

Users have to select one option for most attributes that are part of a Profile.

Step 1: Allow user to select pre-defined or create custom search criteria.

Step 2: Allow user to refine or expand the Search by selecting additional criteria.

Step 3: Allow user to Reply Fields for attributes that search results should show.

Step 4: Group and display user profiles that are part of the search results.

Step 5: Allow user to view breakdown of results grouped in Step 4.

Step 6: Allow user to save search criteria as a query that can be used in the future.

Example: Display Health Status of users who have a Bachelor's Degree (Education Status) and at least two children (Child Status). In this example, Education Status and Child Status are search Criteria while Health Status is a Reply Field.

Algorithm for Searching with Preferences

Users have to select one option for most attributes that are part of a Profile. Every attribute can also be assigned a preference rating on a scale. For instance, a scale may include a range of preference ratings from 1 to 5, with 1 being least important and 5 being most important.

Step 1: Determine number of user profiles that match user-defined search criteria or pre-existing/pre-defined search criteria.

Step 2: Determine user-defined preferences for attributes.

Step 3: If more than one profile matches search criteria, determine which profile is ranked higher based on Reply fields selected and Preferences for those Reply fields.

In some embodiments, the interactive process is implemented wholly or partially by a user software application that is able to complete the requisite tasks using available data, established business rules and analytics to provide users with information relevant to their life situations and criteria. In some embodiments, the user software application runs on a computing device operated by the user 150 and connects over the Internet 160 to the web server 110 of the life analysis system 100. In the next sub-Section (i.e., sub-Section II.B), a process is described for predicting and forecasting life events so that a user can make one or more life decisions.

B. Process for Predicting and Forecasting Life Events to Make Life Decisions

In some embodiments, a process for predicting and forecasting life events is performed by the life analysis system. In some embodiments, the process receives user profile information of a user, receives a set of search criteria, performs a search based on the profile and search criteria, and provides custom search results to the user. In some embodiments, the process further receives a set of log in identity information of the user. In some embodiments, the process further determines whether the profile includes all of the search criteria in the received set of search criteria and, if the profile does not include all the search criteria, indicates that the profile should include all the search criteria. In some embodiments, after performing the search, the process refines the set of search criteria and performs the search again based on the refined set of search criteria. In some embodiments, the process automatically saves search criteria for future retrieval/review after a life analysis search is completed.

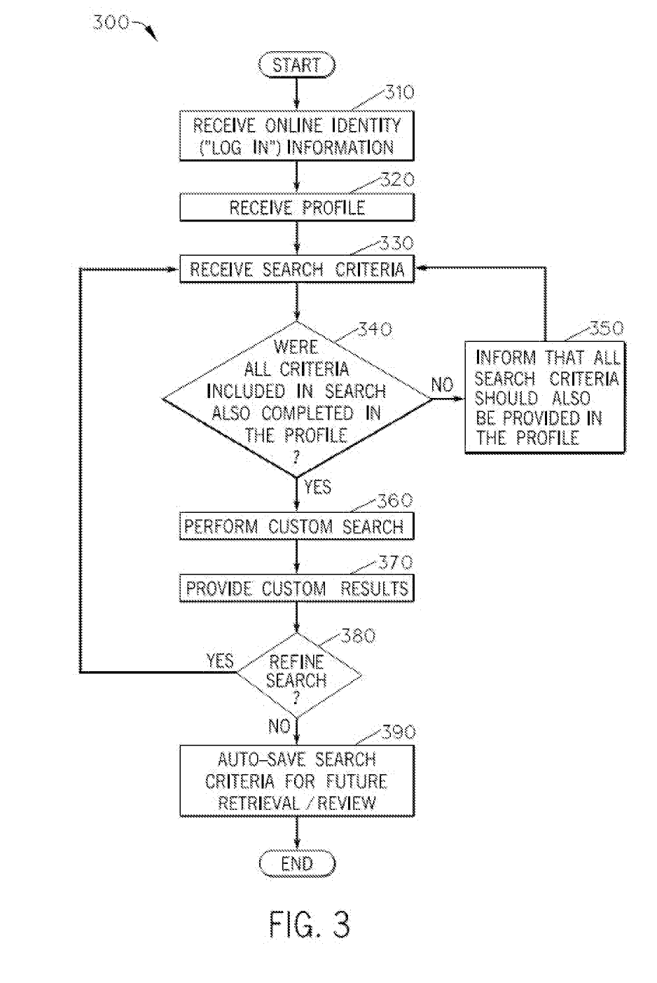

By way of example, FIG. 3 conceptually illustrates a process 300 for predicting and forecasting life events. The process 300 for predicting and forecasting life events is implemented and performed by a life analysis and life event prediction software application. In some embodiments, the life analysis and life event prediction software application runs on the application server computing device 120 of the life analysis system 100.

The process 300 starts when a user attempts to interact with the life analysis system. In some embodiments, the process 300 first receives (at 310) online identity information (i.e., user log in credentials, such as username, password, etc.). When the user is accessing the life analysis system as a new user, the received identity information is compared to a set of existing identity information associated with existing users of the life analysis system. In some embodiments, the process compares the identity information by performing a set of operations associated with the algorithm for determining duplicate log in names.

In some embodiments, the process receives (at 320) a profile for the user. Next, the process 300 receives (at 330) search criteria. As noted above by reference to FIG. 2, in some instances where the user is an existing user with an existing log in name and an existing profile, the process 300 transitions from receiving (at 310) the existing user's identity information to receiving (at 330) the search criteria. Also, in some instances, the received search criteria is search criteria from a previously saved search of the existing user.

Whether the user has selected a saved search or has input new search criteria, the process 300 next determines (at 340) whether all criteria in the received search criteria is also present in the received profile for the user. When the user profile does not include all of the search criteria defined in the received search criteria, the process indicates (at 350) that all of the search criteria should also be provided in the profile of the user. In some embodiments, the process prompts the user by displaying an interactive tool which requires a user operation to continue. For example, a graphical user interface (GUI) of a software application running on a computing device used by the user may display an “OK” button that requires the user to activate (e.g., click) to continue. When the process 300 has completed informing the user that all search criteria should be provided in the user's profile, the process transitions back to 330 to receive the search criteria, which is described above.

On the other hand, when all search criteria from the received search criteria is already provided in the profile, the process 300 performs (at 360) the custom search. In some embodiments, the process performs the search based on one of a custom search and a preferential custom search. In some embodiments, the process performs the custom search when preferences have not been defined by the user. The custom search may include a set of operations that implement the algorithm for searching. In some embodiments, the process performs the preferential custom search when the user has defined a set of preference rankings. The preferential custom search may include a set of operations that implement the algorithm for searching with preferences.

The process then provides (at 370) the results of the custom search to the user. In some embodiments, when the user is not satisfied with the search results, the set of search criteria can be refined by the user. Thus, the process determines (at 380) whether to refine the search. When the set of search criteria does not need further refinement, the process 300 transitions to 390, which is described below. However, if the user wishes to refine the search, then the process 300 transitions back to 330 to receive the refined set of search criteria. After refining the set of search criteria, the process 300 continues in the manner described above. When no further refinement is needed after the process performs the search and provides the search results to the, in some embodiments the process 300 automatically saves (at 380) the search criteria for future retrieval/review by the user. The process 300 then ends.

In some embodiments, a user could be asked to create or define search criteria for performing a search before a profile or log in identity information is provided. Regardless of the order, the search criteria and profile are needed for the system to provide comprehensive results.

C. Example of a Life Analysis System Predicting and Forecasting Life Events

The following examples help to describe how the life analysis system in some embodiments works. Assume that a user is 22 years old, lives in Missouri, and is a law school student. This user would be able to use the system and look for other lawyers who have graduated from her city or school and review their financial, health, and other life statuses, as provided by those users. This information would help the 22 year old user determine her employment prospects, demand in the marketplace for various types of lawyers, number and/or percent of lawyers that appeared in the search results who are married, divorced, in good or poor health, etc. That 22 year old user would then be able to make smart choices and decisions to improve her prospects for success and live an enriching life based on information provided by the rules-based, analytical, data-driven life analysis system.

Users would be able to search for others that have already traveled the path that they are currently traveling on and determine decisions they need to make along the way. They can, also, learn from others' mistakes and not repeat them. For instance, using the 22 year old law student's example, a 45 year old lawyer might indicate that she did not set up a college education fund for her kids and should have done so as soon as she was gainfully employed. The 22 year old would be able to learn from the other lawyer and schedule a reminder within the system or outside the system to schedule a college fund when she has kids.

Similarly, doctors, academic counselors, social services workers, and numerous such professions would be able to use this system to predict outcomes of their cases/clients when a historical record is maintained and other client/case profiles are created and kept updated.

Also, the algorithmic approaches to identifying and providing life events are sufficiently versatile so that the life analysis system could be adapted to create unique and novel financial, medical, and/or other types of systems or products based on user needs as specified through user-provided search criteria and ongoing conversations with other users. Product manufacturers could learn about unique needs of people in specific geographies or people with certain characteristics. Such learning would allow them to design, create and market products for which a demand already exists or is building up.

### III. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

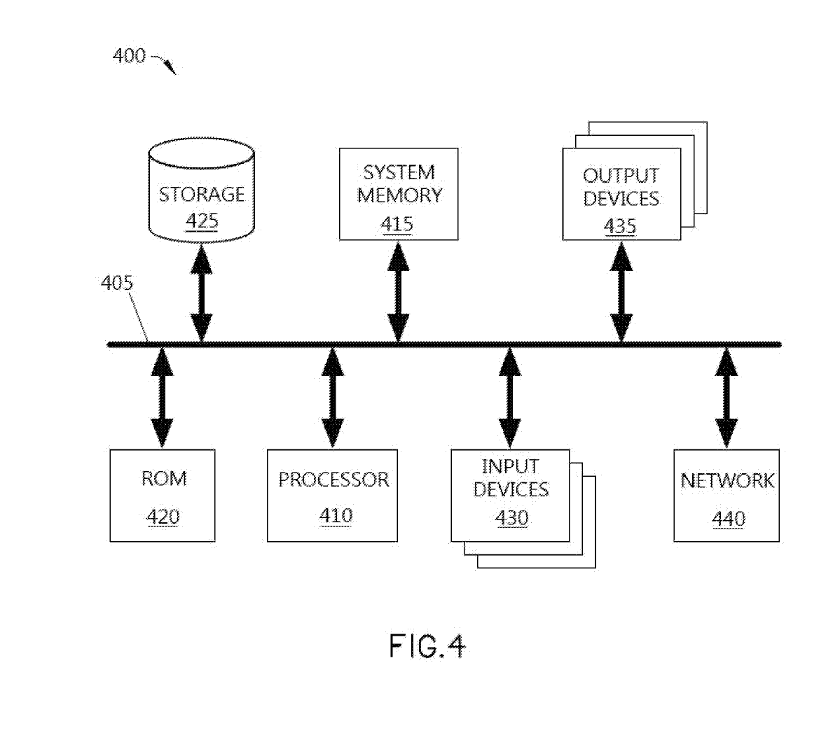

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, each of FIGS. 2 and 3 conceptually illustrates a process. The specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A system that performs a life analysis of a person and predicts life events, milestones, and other life paths based on the analysis, the system comprising:
a user computing device that includes a user software application for a user to interact with the system;
a web server computing device that publishes a web site accessible to the user computing device over the Internet, said web site providing a set of web tools to the user software application that allow the user to interact with the system;
a database management system that accesses a data storage device storing a set of life parameters for each user of a set of people; and
an application server computing device that includes a set of applications that perform a set of life analysis operations based on the set of life parameters in order to provide a life analysis to the user.

2. The system of claim 1, wherein the set of life analysis operations comprises a first set of user and data authentication and validation operations, a second set of custom search operations, and a third set of preferential search operations.

3. The system of claim 1, wherein the set of applications comprises a processing engine application, a set of applications that implement a set of search algorithms, and a set of applications that apply a set of data validation and authentication rules.

4. A non-transitory computer readable medium storing a program which when executed by at least one processing unit of a computing device performs a life analysis of a user, said program comprising sets of instructions for:
receiving a profile of a user;
receiving a set of search criteria;
identifying information that satisfies the search criteria, said identified information associated with a set of other users; and
providing the identified information to the user.

5. The non-transitory computer readable medium of claim 4, wherein the program further comprises a set of instructions for receiving a set of user identity information.

6. The non-transitory computer readable medium of claim 4, wherein the program further comprises a set of instructions for determining whether the profile includes all of the search criteria in the set of search criteria.

7. The non-transitory computer readable medium of claim 4, wherein the set of instructions for identifying information comprises a set of instructions searching information associated with each of a plurality of users stored in a database.

8. The non-transitory computer readable medium of claim 4, wherein the program further comprises a set of instructions for performing one of a custom search and a preferential search based on the set of search criteria.

9. The non-transitory computer readable medium of claim 4, wherein the program further comprises a set of instructions for automatically saving the set of search criteria for future life analysis searches.

10. The non-transitory computer readable medium of claim 4, wherein the program further comprises a set of instructions for refining the set of search criteria.
